(19) United States
(12) Patent Application Publication
(10) Pub. No.: US 2004/0153767 A1
(43) Pub. Date: Aug. 5, 2004

(54) Interactive data broadcasting system

(76) Inventor: Alex Dolgonos, Thornhill (CA)

Correspondence Address: John S. Beulick, Armstrong Teasdale LLP, Suite 2600, One Metropolitan Square, St. Louis, MO, 63102, US

(21) Appl. No.: 10/663,007

(22) Filed: Sep. 16, 2003

Related U.S. Application Data
(60) Provisional application No. 60/411,095, filed on Sep. 17, 2002.

(51) Int. Cl. H04L 1/22

(52) U.S. Cl. 714/18

(57) ABSTRACT

A method of broadcasting data files to selected mobile units, comprising steps of (a) receiving, through a bi-directional wireless network, a data request from a mobile unit, the data request including identification information for the mobile unit, (b) associating the data request with a digital data file; and (c) broadcasting the digital data file together with identification data for the mobile unit over a download channel on a broadcast network that has an overlapping coverage area with the bi-directional wireless network.

This application claims priority to U.S. provisional patent application serial No. 60/411,095 filed Sep. 17, 2002, which is incorporated herein by reference.

### BACKGROUND OF INVENTION

The present invention relates to data broadcasting, and in particular to a system and method for broadcasting digital data to selected subscribers.

Cellular phones have become widely adopted over the last decade, and cellular devices are now being used or developed for e-mail and text messaging applications in addition to voice communications. Cellular phone networks, however, tend to be relatively low bandwidth, low speed systems with the result that only relatively limited amounts of data can be transmitted to individual subscribers. Such systems are cumbersome for transmitting high volumes of data, for example, MP3 files.

Higher speed wireless broadcasting systems have recently emerged, for example, DAB radio transmission systems and the digital radio systems operated by providers such as XM RADIO™, SIRIUS™ and WoddSpace™. Such digital broadcast systems, however, are one way broadcasting systems, and thus do not provide data on demand services in the mobile environment.

Thus, it is desirable to have a data broadcasting system in which the high bandwidth and high speeds of a digital broadcasting system can be combined with the interactivity of a cellular phone network.

### SUMMARY OF THE INVENTION

According to one aspect of the invention, there is provided a method of broadcasting information and data files to mobile units, including steps of (a) receiving, through a bi-directional wireless network, a data request from a requesting mobile unit, the data request including identification information for the requesting mobile unit; (b) associating the data request with a digital data file; (c) broadcasting the digital data file together with identification data for the requesting mobile unit over a download channel on a broadcast network that has a plurality of broadcast channels and an overlapping coverage area with the bi-directional wireless network; and (d) simultaneously with step (c), broadcasting on at least one broadcast channel of the broadcast network other than the download channel a media signal for real-time reception by mobile units tuned to the at least one other broadcast channel. The method may include receiving the broadcast identification data at the mobile unit, determining if the identification data corresponds to the mobile unit, and if so, receiving and storing the digital data file a the mobile unit for future use. The method may also include a step of broadcasting on a selected channel on the broadcast network a prompt to encourage users of mobile units to submit data requests for the digital data file to the bi-directional wireless network.

According to another aspect of the invention, there is provided A mobile unit that includes a bi-directional communications system for receiving and sending transmissions from and to a wireless bi-directional communications network; a first broadcast receiver system for (i) receiving a real time broadcast transmission over a selected one of a plurality of selectable broadcast channels from a broadcast network having a coverage area overlapping with the bi-directional communications network, and (ii) receiving a data file over a download channel from the broadcast network, the selected one broadcast channel and the download channel being different channels; a storage; a user output device selected from the group consisting of a speaker and a display; and a processor connected to the communications systems, the storage and the user output device for (i) sending a request for a playable media file through the bi-directional communications system to the wireless bi-directional communications network, the request including information identifying the mobile unit, and (ii) receiving the data file from the broadcast network through the first broadcast receiver system and storing the data file in the storage while at the same time receiving the real time broadcast transmission from the broadcast network through the first broadcast receiver system and generating a corresponding real time output on the user output device in response thereto.

According to yet another aspect of the invention, there is provided a method for tracking reception information for a wireless subscriber unit, including (a) receiving at a subscriber unit over time a plurality of selectable broadcast signals broadcast over a plurality of selectable channels by a wireless broadcast network; (b) storing at the subscriber unit usage information about use by the subscriber unit of the wireless network; and (c) transmitting the stored usage information from the subscriber unit to a bi-directional wireless communications network that has an overlapping coverage area with the broadcast network.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

Embodiments of the present invention will now be described, by way of example only, with reference to the attached Figures, wherein:

FIG. 1 is a block diagram of a data broadcasting system according to embodiments of the present invention;

FIG. 2 is a block diagram of an interface module of the data broadcasting system of FIG. 1;

FIG. 3 is a block diagram of a mobile unit of the data broadcasting system of FIG. 1; and

FIG. 4 is a block diagram of a method of operation of the data broadcasting system of FIG. 1 according to embodiments of the invention.

### DESCRIPTION OF THE INVENTION

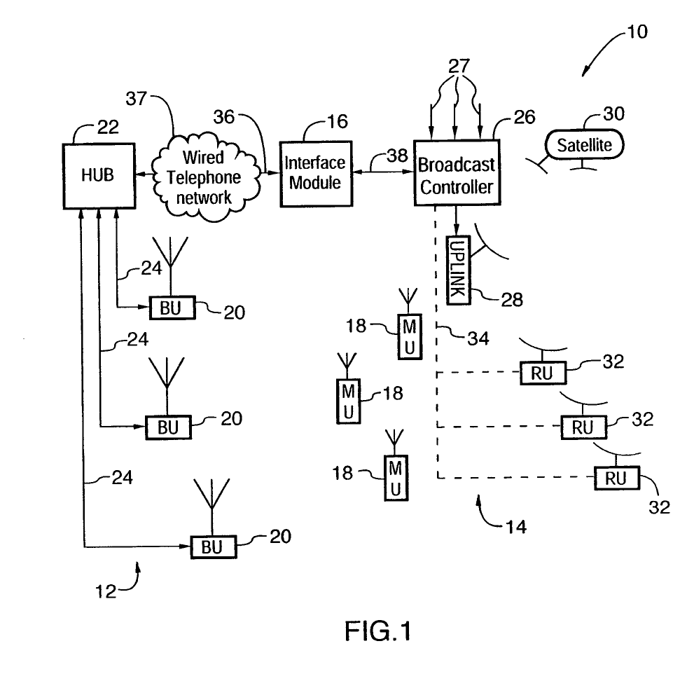

FIG. 1 shows a block diagram of a data broadcasting system, indicated generally by numeral 10, according to embodiments of the present invention. The system 10 includes a bi-directional wireless transmission network, indicated generally by numeral 12, a media broadcast wireless transmission network, indicated generally by numeral 14, an interface module linking the two networks 12 and 14, and a plurality of mobile units 18. In overview, during operation of the system 10 the interface module 16 receives a data request from a mobile unit 18 via the bi-directional network 12, and requests the broadcast network 14 to broadcast the requested data so that the requesting mobile unit 18 can receive the data.

In one example embodiment, the bi-directional and broadcasting networks 12, 14 operate in different ranges of the radio frequency spectrum, but have coverage areas that are at least partially overlapping. The bi-directional network 12 is in an example embodiment a conventional cellular PCS (Personal Communication Service) or phone system that includes a number of wireless base unit transceivers 20 that are each connected by a communications link 24 to a central hub office 22, which in turn is connected to a conventional wired telephone network 37. The bi-directional network 12 may be implemented using any number of multiple access mobile service technologies—by way of non-exclusive examples, it could be a GSM (Global System for Mobile communications) based network such as a GPRS (General Packet Radio Service) network, or could be a CDMA network, TDMA network, FDMA network, or combinations of the forgoing. As known in the art, each base unit 20 communicates with mobile units 18 that are located within the respective cell or service area that the base unit services, with handoffs between the base units 20 as the mobile units 18 move being coordinated by the central hub 22. The central hub 22 is commonly referred to as the MTSO (Mobile Telephone Switching Office) and in addition to controlling and coordinating the operation of the base stations 20 also acts as the interface with the conventional wired telephone system 37. The bi-directional network 12 may be a unicast system in that, at any given time, a particular mobile unit 18 will only receive a specific data transmission at an assigned frequency or frequencies from only a single base unit 20.

The media broadcast network 14 is in an example embodiment a wireless digital data broadcasting system that includes a number of media broadcast channels each having a higher downstream data transmission rate than the bi-directional network 12. A number of wireless digital data broadcasting systems known in the art could be used as broadcast network 14, including for example systems based on the digital radio related DAB (Digital Audio Broadcast) standards, or digital radio broadcast systems such those operated by Sirius™, XM Radio™ or WorldSpace™, among others. Systems intended for broadcasting wireless digital video data, for example systems based on the DVB-S (Digital Video Broadcast—Satellite) and DVB-T (Digital Video Broadcast-Terrestrial) standards could also be used in implementing broadcast network 14.

The exemplary broadcast network 14 of FIG. 1 includes a central broadcast controller 26 operatively connected to an uplink antenna 28 for transmitting digital data such as audio data to an orbiting satellite 30. The broadcast controller 26 receives digital data for several discrete broadcast channels from various content providers such as radio stations through inputs 27, and assembles and transmits the data to satellite 30. The satellite retransmits the digital data as QPSK signals or other suitably encoded signals back to a respective satellite coverage area on the earth's surface, where the data can either be received directly by mobile units 18, or received by terrestrial repeater units 32 that then retransmit the digital data to mobile units 18 located within respective coverage areas. Terrestrial repeater units 32 will generally be positioned in denser urban areas and other locations where direct reception by mobile units 18 from satellite 30 is impaired. In an example embodiment, repeater units 32 are DAB compliant, or use some other cyclically extended OFDM (Orthogonal Frequency Division Modulation) or MCM (multi-carrier modulation) based scheme for wireless terrestrial broadcast of digital data. OFDM is an attractive form of modulation due to its high spectral efficiency and resistance to noise and multi-path effects. Repeater units 32 may be arranged as a single frequency network, meaning that each of the units 32 transmits the same data bits at the same frequency at substantially the same time (in contrast to the unicast nature of bi-directional system 12). In OFDM based systems, it is generally more efficient to use several low power transmitters having overlapping coverage areas than using a single high power transmitter, and the use of several transmitters in an SFN (Single Frequency Network) reduces the potential of shadowed zones in the coverage area.

In some embodiments, repeater units 32 may be omitted entirely, with mobile units only receiving data broadcasts from the satellite 30. In other embodiments, the repeater units 32 may be linked to the central broadcast transmitter 26 by a communications link that excludes the satellite 30, for example, by a land-line indicated by phantom line 34. Land-line 34 may be, among other things, a dedicated fibre link, a wireless link or could include a shared infrastructure link such as a cable TV plant. In some embodiments, repeater stations 32 and satellite 30 may be omitted, with terrestrial wireless data broadcasts coming directly from an antenna at the central broadcast controller 26.

As noted above the interface module 16 links the bi-directional network 12 and the broadcast network 14. In an example embodiment, the interface module 16 is connected by a first communications link 36 to the central hub 22 to receive data requests from mobile units 18. The first communications link 36 may include wired telephone network 37, or a dedicated line or wireless link, or a network such as the Internet, among other things. The interface module 16 is connected to the central broadcast controller 26 by a second communications link 38 to send requested data to the broadcast controller for transmission to requesting mobile units 18. The second communications link 38 may be a high speed link. In an example embodiment, the broadcast controller 26 and interface module 16 are at the same physical location, and may be connected by a dedicated bus or through an intranet. However, some or all of the components of the interface module 16 could be located at a different physical location than broadcast controller 26, and the link 38 could, by way of example only, be wired or wireless, could be a real or virtual dedicated link, or could include a wired public telephone network or a computer network such as the Internet, or combinations of the forgoing.

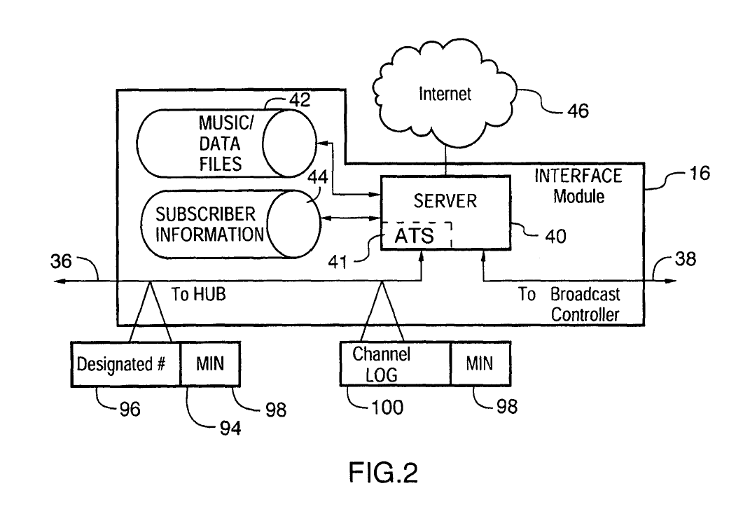

With reference to FIG. 2, the interface module 16 is, in an example embodiment, implemented using one or more suitably configured server computer systems 40. The server has access to a database of requestable data files 42, and access to a database of subscriber information 44. The data file database 42 is, in one embodiment, stored on a storage medium that is local to the server 40, and includes digital audio files such as MP3 files. The subscriber information database is also, in one embodiment, stored on storage medium that is local to the server 40, and includes subscriber information necessary to support the functionality described below. In an example embodiment, the interface module includes a link to a network such as the Internet/World Wide Web 46, enabling the server 40 to receive additional data files for storage in database 42 and subscriber information for storage in database 44. In one embodiment, the interface module 16 includes an automated telephone system 41 for answering and processing data requests arriving on first communications link 36. In various embodiments, different functions of interface module 16 are carried out on computer systems located at different physical locations and connected by communications links that may include the intranet and or the Internet, for example.

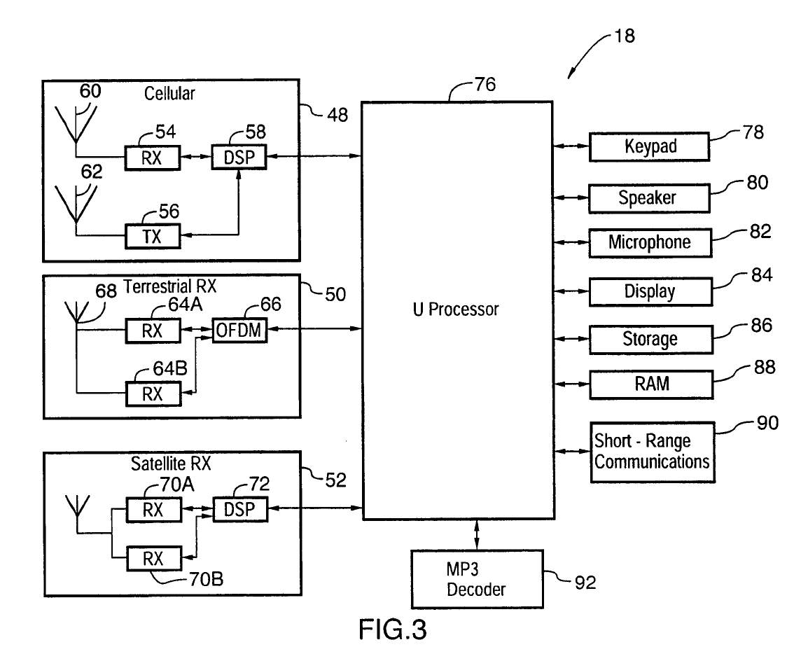

With reference to FIG. 3, a block diagram of a mobile unit 18 according to example embodiments of the invention is shown. In example embodiments, the mobile unit 18 is a handheld device and includes three communications subsystems, namely a bi-directional cellular communications subsystem 48 for communicating with bi-directional network 12, a terrestrial digital broadcast receiver subsystem 50 for receiving digital broadcasts transmitted by terrestrial repeater units 32, and a satellite broadcast receiver subsystem 52 for receiving digital broadcasts transmitted from satellite 30. Mobile units 18 intended to be used only in areas having coverage by terrestrial repeater units 32 may not have a satellite broadcast receiver subsystem 52, and conversely, mobile units 18 that will always be used in areas having direct satellite coverage may not include a terrestrial broadcast receiver subsystem 50.

The bi-directional cellular communications subsystem 48 includes a receiver 54, a transmitter 56, and associated components such as one or more antenna elements 60, 62, local oscillators (not shown), and a processing module such as a digital signal processor (DSP) 58. The particular design of the cellular communications subsystem 48 will depend on the bi-directional communication network in which the mobile unit 18 is intended to operate (For example GPRS, CDMA, etc.). Signals received from a base unit 20 of cellular network 12 are input to the receiver 54 that may perform such common receiver functions as signal amplification, frequency down conversion, filtering, channel selection, analog to digital conversion and the like. DSP 58 then performs demodulation and decoding on the received signal. On the uplink side, DSP 58 processes, including encoding and modulating, signals to be transmitted and inputs the processed signals to the transmitter 56 for digital to analog conversion, frequency up conversion, filtering, amplification, and transmission to the network 12 via the antenna 62. DSP 58 also controls the operation of receiver 54 and transmitter 56

The terrestrial receiver subsystem 50 includes first and second receivers 64A and 64B and associated components such as antenna element 68, local oscillators (not shown), and a processing module, which in an example embodiment is an OFDM signal processor 66. Signals received from terrestrial repeater units 32 are input to the receivers 64A and 64B that may perform such common receiver functions as signal amplification, frequency down conversion, filtering, channel selection, analog to digital conversion and the like. Two receivers are provided so that subsystem 50 can simultaneously process two different channels, one of which carries digital audio broadcast for real-time listening, and one of which carries audio files that can be stored at the mobile unit 18 for future use. OFDM signal processor 66 performs demodulation and decoding on the received signals, and is configured to process signals from the two receivers 64A and 64B simultaneously. The demodulation and decoding protocol used by the terrestrial receiver subsystem 50 corresponds to the protocol used by repeater units 32, for example, in one embodiment, OFDM signal processor 66 is configured to process DAB compliant signals transmitted by repeater units 32.

The satellite receiver subsystem 52 also includes two receivers 70A and 70B and associated components such as antenna element 74, local oscillators (not shown), and a processing module, which may be one or more DSPs 72, for example. Signals received from satellite 30 are input to the receivers 70A and 70B that each perform such common receiver functions as signal amplification, frequency down conversion, filtering, channel selection, analog to digital conversion and the like. Two receivers are provided so that subsystem 52 can simultaneously process two different channels, one of which carries digital audio broadcast for real-time listening, and one of which carries audio files that can be stored at the mobile unit 18 for future use. DSP 72 then performs demodulation and decoding on the received signals, and is configured to process signals from the two receivers 70A and 70B simultaneously.

The mobile unit 18 includes a microprocessor 76 that controls the overall operation of the mobile unit 18. The microprocessor 76 interacts with and controls the communications subsystems 48, 50 and 52, and selectively determines, based on QoS (Quality of Service) of detected signals whether the signals received from the terrestrial receiver subsystem 50 or the satellite receiver subsystem 52, or a combination of both, should be used as data received from the broadcast network 14. The mobile unit 18 also includes a number of other sub-systems that interact with the microprocessor 76, including for example, a keypad 78, a speaker 80, a microphone 82, a display 84, at least one persistent storage 86, RAM (Random Access Memory) 88, a short range communications subsystem, and, in an example embodiment, a digital music decoder such as MP3 decoder 92. Operating system and other software applications for the microprocessor are installed on the persistent storage 86 to enable the mobile unit to perform the functions described herein. The operating system and specific applications, or parts thereof, may be loaded into volatile memory such as RAM 88 during operation of the mobile unit 18.

The short-range communications subsystem 90 may provide for communication between the mobile unit 18 and another device such as the personal computer of the user of mobile unit 18. By way of example, short-range communications subsystem 90 may include a Bluetooth™ communication module to communicate with a similarly enabled personal computer. If the personal computer is connected to the Internet, the Bluetooth connection could be used to provide the mobile unit 18 with a temporary high speed link to the Internet for downloading music and other files through the personal computer.

The operation of the data broadcasting system 10 will now be discussed in greater detail, according to embodiments of the invention. In one example embodiment, the users of mobile units 18 are registered subscribers for whom information is stored in the subscriber information database 44 of interface module 16. In an example embodiment, for each subscriber, the database 44 includes a subscriber record that includes unique identifying information for the subscriber, for example, a MIN (Mobile Identification Number). The subscriber record may also include contact and billing information for the subscriber, for example e-mail and land addresses, billing preferences and credit card information. Such information may be obtained as part of a registration process —for example, the subscriber could register through a Web site maintained on the Internet 46 by the server 40 of Interface module 16. The subscriber records stored in database 44 could also include historical information such as past data requests made by each subscriber. During the registration process, each mobile unit is provided with a decryption key for decrypting downloaded data files. The decryption key stored on subscriber mobile units 18 may be periodically updated, for example through broadcasts through the broadcast network 14, through periodic automated calls through bi-directional network 12, or through periodic updates received through the Internet 46. Alternatively, a file specific decryption key could be provided to the mobile unit over wireless network 12 upon successful ordering of a file for download.

During normal operation of the system 10, various digital radio stations broadcast on assigned broadcast channels over broadcast network 14 to a plurality of listeners having digital audio receivers that are tuned to desired channels. The broadcast signals may be free to all who have a suitable receiver, or all or selected channels may be available only to those who are subscribers (for example, XM Radio™ broadcasts are generally limited to paid subscribers). Mobile units 18 are configured to function as digital audio receivers to receive, via terrestrial or satellite communications subsystems 50, 52 the broadcasts and allow a person to listen in real time to a selected broadcast channel over speaker 80 (which may be a headphone device).

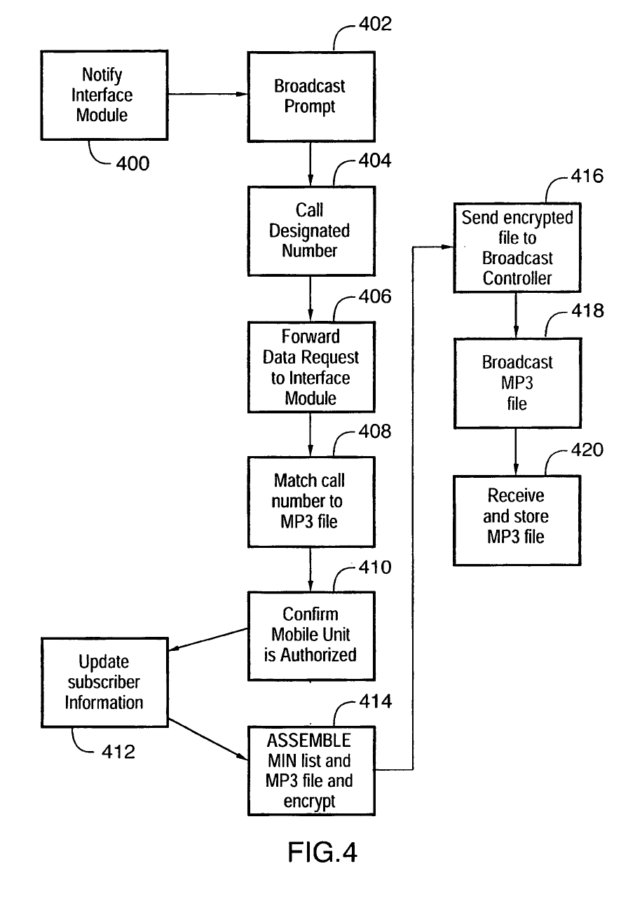

In one embodiment of the system, the system 10 is used to send digital audio files such as MP3 files to requesting subscribers in the following manner. With reference to FIG. 4, a prompt is broadcast (step 402) over broadcast network 14 to the listeners of a particular digital radio station (station “A”) to encourage them to take action to submit a data request. The prompt may take the form of an audio prompt, for example a DJ making the statement “If you liked that song that we just played, you can download the MP3 file for $X by dialling 63 within the next five minutes”. Digital radio broadcasts typically include some text information that is displayed on a receiver screen that includes information such as channel identification and the name of the current song being played and the artist for the song. Thus, a visual prompt could be provided, instead of or in addition to an audio prompt, in the form of a broadcast text message for display on the screen display 84 of the mobile unit 18. The text message could say “To order MP3 file of this song for $X, dial *63 now!”.

If the subscriber wants the MP3 file, he or she dials the designated call number and presses a “send” or similar key on the keypad 78 of his or her mobile unit 18. The call is transmitted through cellular communication subsystem 48 and is picked up by one of the base units 20 of bi-directional network 12 (step 404). By prearrangement with the operator of bi-directional network 12, the central hub 22 has been pre-configured to forward calls to the designated call number to the interface module 16 (step 406). In particular, when the subscriber initiates a call using the designated call number, the mobile unit 18 transmits a call initiation packet to the bi-directional network that includes, among other things, the designated call number that the mobile unit 18 is calling (in this example <*63>), and a unique identifier for the mobile unit 18, for example its MIN. Such information is transferred by the central hub 22 as a data request to the interface module 16 over first communication link 36. FIG. 2 shows an illustrative data request packet 94, which contains the designated call number 96 and MIN 94. In one embodiment of the invention, the call session with the mobile unit 18 is terminated automatically once the server 40 acknowledges to the network 12 that it has received the data request 94.

Server 40 has been pre-configured to associate the designated call number 96 in the data request 94 with a particular MP3 audio file that is stored in the music/data files database 42, and possibly to associate the designated call number 96 with a particular radio station. By way of example, the operator of the interface module 16 may have a prearrangement with the carrier that operates bi-directional network 12 that all calls to a predefined set of designated numbers (for example numbers *60 to *90) will be routed to the interface module 16. The operator of the interface module may also have prearrangements with the radio stations that broadcast on the broadcast network 14 that one or more designated call numbers are reserved for use by respective radio stations. Prior to broadcasting the prompt in step 402, the radio station that intends to solicit data requests for an MP3 file sends a notification (step 400) to the server 40 of the interface module 40 that at a designated time the radio station will be broadcasting a prompt to users to use a designated call number to order a designated MP3 file for a designated price within a designated time period. Such notification could be included in the digital data sent over inputs 27, and routed to the interface module 16 by broadcast controller 27, or could be provided to the interface module 16 through a more interactive process, such as over Internet 46. If the notification process is interactive, the interface module 16 can send a confirmation to the radio station that notification has been received. Server 40 can confirm that it has access to the designated MP3 file on music/data file database 42. The designated time period during which an MP3 file may be ordered may be a strictly specified time, or could be open ended until a further notification is received from the radio station. As suggested above call numbers may be pre-allocated to specific radio stations, or could be temporarily assigned at the time that notification step 400 is performed. Pre-allocated numbers may offer an advantage in some circumstances in that subscribers to a specific station may find it more convenient to use a consistent call number or set of call numbers to download MP3 files from a particular station.

Turning again to step 406 of FIG. 4, when the server 40 receives the data request 94 from the requesting mobile unit 18 via bi-directional network 12, it matches the designated call number 96 in data request 94 to its associated MP3 file in database 42 (step 408). The server 40 also accesses the subscriber information file in database 44 to locate the subscriber record that corresponds to MIN 98 in data request 94 to verify that the requesting mobile unit 18 belongs to an authorized subscriber (step 410). The server 40 may also update the subscriber record associated with the requesting mobile unit 18 to note that the subscriber ordered the designated MP3 file for a designated cost at a specific time (step 412). In response to any given broadcast prompt, the interface module server 40 will generally receive data requests from several different mobile units 18 for the subject MP3 file during the designated time period, and performs steps 410 and 412 for each received data request. In an example embodiment, the server 40 builds a list of MINs for each of the mobile units 18 from which a data request for the MP3 file is received within the designated period. At the end of the designated period, the server 40 encrypts the list of MIN's and a copy of the designated MP3 file (step 414), and sends the encrypted MIN's and MP3 file to the broadcast controller 26 over link 38 (step 416).

In an example embodiment, the broadcast system 14 has one or more designated data file download channels on which MP3 files can transmitted. The download channel(s) may be shared among many radio stations, with use of the channel being coordinated by interface module 16. Thus, when the server 40 sends the encrypted list of MIN's and copy of the MP3 file to the broadcast controller 26, it may also send information identifying the radio station that sent out the prompt soliciting the orders, and an identification of the designated download channel on which the MP3 file is to be broadcast and a specified time at which the broadcast of the MP3 file is to occur. At the specified time, the broadcast controller 26 broadcasts the encrypted MINs of requesting subscribers and the designated MP3 file over the communications network 14 on the designated download channel (step 418).

In one embodiment, mobile units 18 are configured to monitor the designated download channel. For example, if a requesting mobile unit 18 is in the coverage area of terrestrial repeater units 32, one of the receivers 64B of terrestrial communications subsystem 50 will be tuned to the designated download channel. The other receiver 64A may be tuned to the channel of the radio station that the user of the mobile unit is currently listening to such that the mobile unit 18 can continue to play the real-time broadcast from the radio station while t the same time receiving and storing the requested MP file. Upon detecting a transmission on the designated download channel, a requesting mobile unit 18 is configured to decrypt, using the stored decryption key, the list of MIN's in the broadcast file to determine if the broadcast MP3 file is intended for it. If so, the mobile unit 18 proceeds to receive and store the broadcast MP3 file in persistent storage 86 (step 420) so that it can be played back at a latter time. Mobile unit 18 may notify the user by a visual display on screen display 86 and/or some other method of notification such as an audible beep on speaker 80 that the requested MP3 file has been successfully downloaded and stored. As noted above, the mobile units 18 include an MP3 decoder subsystem. The mobile units are enabled to act, in one mode, as MP3 players to play files that are stored in persistent storage 86. The MP3 file could be decrypted upon download, or could be stored in an encrypted state and decrypted only as it is being played.

It will thus be appreciated that the mobile units 18 of the present invention function, in one embodiment, as cellular phones, digital radios, and MP3 players. The system of the present invention gives radio stations and network operators the opportunity to push digital audio files out to listeners in response to requests for the files from listeners.

Server 40 may perform some billing related processing. For example, if credit card information is included in subscriber files, the server 40 could automatically charge the subscriber's card the appropriate fee whenever a music file is downloaded. Such charging may be done with each transaction, or on a periodic basis. Alternatively, in some business models, billing of subscribers for downloaded files could be the responsibility of the operators of either network 12 or network 14, and the server 40 could transfer the information required to the billing systems associated with such networks to allow them to charge an account maintained by the subscriber.

It will be appreciated that many modifications could be made to the process of FIG. 4. For example, the broadcast of the prompt may be received on a digital radio other than the mobile unit 18 in some embodiments. Instead of using a “*” designated call number in the prompt such as <*63>, in some embodiments, the designated number may be a conventional telephone number (for example a 1-800 number) associated with the interface module 16 by the operator of wired telephone network 37, in which case the system would operate without any dependence on a particular wireless bi-directional network. In such an embodiment the bi-directional network 22 would simply switch the call through to wired telephone network 37, which would then direct the call to an automated telephone system (ATS) 41 at the Interface module.

In some embodiments, ATS 41 could establish an automated interactive communications session between the interface module 16 and the requesting mobile unit 18 via bi-directional network 12 and communications link 36 in order to process the data request from the mobile unit 18, and could provide the user of the mobile unit 18 with audio and or visual confirmation that the data request has been received. ATS 41 could present predetermined options to the user of mobile units 18, for example, it could provide an audio prompt stating “Press <1> now for the extended mix of this song or <2> for the regular version”, or “Press <1> to also download Song B, also by this artist”. Based on options selected by requesting mobile units 18 during their respective interactive sessions with ATS 41, the server 40 would assemble the correct MP3 files and corresponding MIN's and send the encrypted files to the broadcast controller 26 for download over the designated broadcast channel at the appropriate time.

In embodiments where an interactive session is established between a requesting mobile unit 18 and the interface module 16 over the bi-directional network 12 and communications link 36, additional pre-determined information could be provided to the mobile unit 18 to facilitate the download process. For example, a new key for decrypting the requested MP3 file when it is downloaded could be sent over bi-directional network 12 to the mobile unit 18 during the interactive communications session. Additionally, in some embodiments, the interface module 16 may send instructions to the mobile unit 18 that the download will occur at a designated time on a designated download channel, thus allowing the appropriate receiver subsystem of the mobile unit 18 to tune to the designated download channel at the designated time. In some embodiments, the notification of the download time and channel could be broadcast over network 14, perhaps as an electronic notification on the channel of the radio station that sent out the prompt.

Although the above description has focussed on the broadcasting of MP3 audio files, other types of digital audio files and digital data files could be broadcast to requesting subscribers using the system and methods of the present invention. For example, digital video files such as MPEG files could be broadcast, as could computer program files. The broadcast network 14 could be a television video broadcast network, with mobile units 18 being configured as digital video receivers and stored video playback devices.

In some embodiments of the invention, the system 10 could be used to track usage details of the broadcasting system 14 by individual mobile units 18 that goes far beyond the data download tracking mentioned above. In particular, the mobile units 18 could each be configured to track information about the real-time broadcasts that they receive over the broadcast network 14 and transmit such tracked information over the bi-directional network 12 to the interface module 16 for storing in subscriber information database 44. Such information could be used by the operator of the broadcast network 14 for many purposes, for example for general informational purposes, for targeted marketing purposes, for setting advertising rates, and for pay per use schemes.

In one exemplary embodiment, a specialized application running on the microprocessor 76 of each mobile unit is configured to track when the mobile unit is used as a receiver device for real-time broadcasts over the broadcast network 14. In particular, when a user tunes the mobile unit 18 to receive a selected broadcast channel from the broadcast network 14 through the broadcast communications sub-system 50, the mobile unit 18 creates a “channel log” in local memory that may include, among other things, an identification of the selected broadcast channel, the time that the channel was selected, and information indicating the duration of time the channel has been listened to. The channel log information is periodically transmitted by the mobile unit 18, along with the MIN for the subject mobile unit, through the bi-directional network to the interface module 16 where the server 40 stores the log information in subscriber information database 44, or otherwise disseminates the information. The “channel log” could include information that is included in broadcast signals (for example time stamps, channel information, and information identifying songs) and/or could include time and channel identifying information generated by the mobile unit.

In such an embodiment, a detailed broadcast network use profile for each of the mobile units 18 can be maintained. If the mobile units are configured to frequently up-load to the interface module 16 their respective channel logs, use information for any particular broadcast channel can be tracked in an almost real-time manner. As known in the art, the bi-directional network 12 maintains control channels in which information is continuously exchanged between the mobile units 18 and the network 12. When they are enabled, the mobile units 18 frequently transmit identification information over the control channels, allowing the bi-directional network 12 to track signal strength from the mobile units 18 in order to allocate network resources and coordinate call handoffs as the mobile units move. In one example embodiment of the present invention, the mobile units 18 are each configured to transmit their respective channel log information over the control channels of bi-directional network 12, and the hub 22 is configured to extract the channel log information 100 (including the respective MINs 98 of the source mobile units) and send it over the communications link 36 to the interface module 16 (see FIG. 2). The channel log information is, in an example embodiment, sent as an add on to every or to selected periodic control channel transmissions made by a subject mobile unit 18, such that the broadcast channel usage information received at interface module 16 is virtually real-time information.

Alternatively, in some embodiments, the mobile units 18 are configured to send out a channel log only when a change in reception status occurs, for example when a channel is changed or the digital broadcast receiver turned off. In other embodiments, the mobile units do not use the control channels of the bi-directional network to upload channels logs, but rather are configured to automatically dial a designated number to upload the information at periodic time intervals or upon receiving a broadcast prompt over the network 14. Broadcast usage tracking could be limited to selected mobile units 18, the users of which have consented to such tracking and who may be provided with participation incentives.

The above-described embodiments of the present invention are intended to be examples only. Alterations, modifications and variations may be effected to the particular embodiments by those skilled in the art without departing from the scope of the invention, which is defined by the claims appended hereto.

1. A method of broadcasting information and data files to mobile units, comprising steps of:
(a) receiving, through a bi-directional wireless network, a data request from a requesting mobile unit, the data request including identification information for the requesting mobile unit;
(b) associating the data request with a digital data file;
(c) broadcasting the digital data file together with identification data for the requesting mobile unit over a download channel on a broadcast network that has a plurality of broadcast channels and an overlapping coverage area with the bi-directional wireless network; and
(d) simultaneously with step (c), broadcasting on at least one broadcast channel of the broadcast network other than the download channel a media signal for real-time reception by mobile units tuned to the at least one other broadcast channel.

2. The method of claim 1 further including:
(e) receiving the broadcast identification data at the requesting mobile unit, determining if the identification data corresponds to the requesting mobile unit, and if so, receiving and storing the digital data file at the requesting mobile unit for future use.

3. The method of claim 2 further including:
simultaneously with step (e) receiving the signal broadcast on the at least one other broadcast channel for real-time reception at the requesting mobile unit.

4. The method of claim 1 further including, prior to step (a), a step of broadcasting on the at least one other broadcast channel a prompt to encourage users of the mobile units to submit data requests for the digital data file to the bi-directional wireless network.

5. The method of claim 4 wherein the prompt includes information encouraging the users of the mobile units to contact a specified address associated with the bi-directional wireless network to request the digital data file.

6. The method of claim 5 wherein the bi-directional wireless network is a cellular network and the specified address is a telephone number.

7. The method of claim 6 wherein the data request includes the telephone number and in step (b) the telephone number is used as identifying information to associate the data request with the digital data file.

8. The method of claim 4 wherein the prompt includes information causing a real-time aural message over a speaker at receiving mobile units.

9. The method of claim 4 including receiving data requests from a plurality of requesting mobile units only for a finite predetermined duration after broadcasting the prompt, the data requests each including identification information for the respective requesting mobile units, and in step (c) the digital data file is broadcast together with identification data for the requesting mobile units for which data requests were received during the finite predetermined duration.

10. The method of claim 1 wherein the data request includes identifying information for the digital data file, and including, between steps (b) and (c), transmitting the digital data file from a data file storage to a broadcast location for subsequent broadcast over the download channel.

11. The method of claim 1 including, after step (a) and prior to step (c) transmitting through the bi-directional wireless network to the requesting mobile unit information identifying the download channel.

12. The method of claim 1 wherein the broadcast network includes a plurality of terrestrial OFDM transmitters arranged as a single frequency network.

13. The method of claim 12 wherein the broadcast network broadcasts digital audio signals and the data file is a digital audio file.

14. The method of claim 13 wherein the digital audio file in an MP3 file.

15. The method of claim 1 including:
receiving from plurality of the mobile units over the bi-directional wireless network information about usage by the mobile units of the broadcast network, including information about channels tuned to by the mobile units and length of usage of the tuned to channels.

16. A mobile unit comprising:
a bi-directional communications system for receiving and sending transmissions from and to a wireless bi-directional communications network;
a first broadcast receiver system for (i) receiving a real time broadcast transmission over a selected one of a plurality of selectable broadcast channels from a broadcast network having a coverage area overlapping with the bi-directional communications network, and (ii) receiving a data file over a download channel from the broadcast network, the selected one broadcast channel and the download channel being different channels;
a storage;
a user output device selected from the group consisting of a speaker and a display; and
a processor connected to the communications systems, the storage and the user output device for (i) sending a request for a playable media file through the bi-directional communications system to the wireless bi-directional communications network, the request including information identifying the mobile unit, and (ii) receiving the data file from the broadcast network through the first broadcast receiver system and storing the data file in the storage while at the same time receiving the real time broadcast transmission from the broadcast network through the first broadcast receiver system and generating a corresponding real time output on the user output device in response thereto.

17. The mobile unit of claim 16 wherein the first broadcast receiver system is a terrestrial broadcast receiver, and the mobile unit also including a satellite receiver system for (i) receiving a real time broadcast transmission over a selected one of a plurality of selectable satellite broadcast channels from a satellite network having a coverage area overlapping with the bi-directional communications network, and (ii) receiving a data file over a satellite download channel from the satellite network, the selected one satellite broadcast channel and the satellite download channel being different channels;
wherein the processor is configured for receiving the data file through one of the first broadcast receiver system and the satellite receiver system and storing the data file in the storage while at the same time receiving the real time broadcast transmission through one of the first broadcast receiver system and the satellite receiver system and generating a corresponding real time output on the user output device in response thereto.

18. A method for tracking reception information for a wireless subscriber unit, comprising:
(a) receiving at a subscriber unit over time a plurality of selectable broadcast signals broadcast over a plurality of selectable channels by a wireless broadcast network;
(b) storing at the subscriber unit usage information about use by the subscriber unit of the wireless network; and
(c) transmitting the stored usage information from the subscriber unit to a bi-directional wireless communications network that has an overlapping coverage area with the broadcast network.

19. The method of claim 18 wherein the usage information is transmitted to the bi-directional wireless communications network at predetermined intervals.

20. The method of claim 18 wherein the usage information is transmitted to the bi-directional wireless communications network upon the subscriber unit receiving instructions over one of the bi-directional wireless communications network and the wireless broadcast network.

21. The method of claim 18 wherein the bi-directional wireless communications network includes a plurality of base units connected to a coordinating hub, the base units having associated coverage areas for communicating with the subscriber unit as it moves through a coverage area of the bi-directional wireless communications network, the bi-directional wireless communications network including a dedicated control channel through which network administration information is substantially continuously communicated between the subscriber unit and the bi-directional wireless communications network, wherein in step (c) the stored usage information is transmitted through the dedicated control channel.

22. The method of claim 21 including receiving through the control channel stored usage information from a plurality of subscriber units, and compiling the stored usage information at the coordinating hub.

23. The method of claim 18 wherein the usage information includes identification of channels audited by the subscriber unit and the time periods during which the identified channels were audited.
